(19) United States
(12) Patent Application Publication
(10) Pub. No.: US 2011/0154248 A1
(43) Pub. Date: Jun. 23, 2011

(54) INFORMATION PROCESSING APPARATUS AND SCREEN SELECTION METHOD

(76) Inventor: Junya Tsuruoka, Ome-shi (JP)

(21) Appl. No.: 12/942,901

(22) Filed: Nov. 9, 2010

(30) Foreign Application Priority Data
Dec. 22, 2009 (JP) JP 2009-291291

(51) Int. Cl. G06F 3/048

(52) U.S. Cl. 715/781

(57) ABSTRACT

According to one embodiment, an information processing apparatus includes a screen arrangement information storing module, a window generating operation detector, a selection operation detector, a screen determination module, and a window display module. The screen arrangement information storing module store screen arrangement information indicative of an arrangement of screens. The window generating operation detector detects a window generating operation for generating a window. The selection operation detector detects a selection operation for selecting a screen which is to display the window from the screens, in response to detection of the window generating operation. The screen determination module determines the screen which is to display the window, based on the selection operation and the screen arrangement information. The window display module displays the window on the determined screen.

### CROSS-REFERENCE TO RELATED APPLICATIONS

This application is based upon and claims the benefit of priority from Japanese Patent Application No. 2009-291291, filed Dec. 22, 2009; the entire contents of which are incorporated herein by reference.

### FIELD

Embodiments described herein relate generally to an information processing apparatus which displays images on screens, and a screen selection method applied to the information processing apparatus.

### BACKGROUND

In recent years, computers having the function for managing a plurality of physically or logically set screens have been gaining in popularity. For example, a multi-display system which handles display devices connected to a single computer is used, as if these display devices are a single display device. In addition, a virtual desktop system in which virtual screens are set for a single display device, and the virtual screens are switched and displayed on the single display device is used.

Jpn. Pat. Appln. KOKAI Publication No. 2008-164988 discloses a multi-display system which manages displays. In this multi-display system, a window is displayed on a display pre-designated in association with each of application programs. In this multi-display system, a display, which is used for display when each of application programs is executed, is designated in association with each application program, and the information relating to the designation is stored as display selection information. When an application program is started, the window of this program is displayed on the display designated by the display selection information.

In the multi-display system of KOKAI Publication No. 2008-164988, screens which are to display the windows of application programs are pre-designated in association with the respective application programs. Thereby, when an application program is started, the window of this application program can be displayed on the designated screen.

When a new application program has been added, however, it is necessary to perform an operation of adding display selection information which designates a screen which is to display the window of the new application program. In addition, in order to display a window on a screen which is different from the screen designated by the display selection information, it is necessary to rewrite the display selection information, or to perform an operation of shifting, after the window is displayed on a screen, the window to another screen. Thus, in the multi-display system using the above-described display selection information, it is difficult to set up screens on which windows are displayed, according to, e.g. the condition of use of the screens.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary perspective view showing the external appearance of an information processing apparatus according to an embodiment.

FIG. 2 shows an exemplary system configuration of the information processing apparatus according to the embodiment.

FIG. 3 is an exemplary block diagram showing the functional structure of a screen selection program executed by the information processing apparatus according to the embodiment.

FIG. 4 is an exemplary conceptual view for illustrating an example of the operation of screen selection performed by using the screen selection program of FIG. 3.

FIG. 5 is an exemplary conceptual view for illustrating an example of screen arrangement information used by the screen selection program of FIG. 3.

FIG. 6 shows an example of an operation for selecting a screen from display devices by using the screen selection program of FIG. 3.

FIG. 7 shows another example of the operation for selecting a screen from display devices by using the screen selection program of FIG. 3.

FIG. 8 shows still another example of the operation for selecting a screen from display devices by using the screen selection program of FIG. 3.

FIG. 9 shows still another example of the operation for selecting a screen from display devices by using the screen selection program of FIG. 3.

FIG. 10 shows an example of an operation for selecting a screen from virtual screens by using the screen selection program of FIG. 3.

FIG. 11 shows another example of the operation for selecting a screen from virtual screens by using the screen selection program of FIG. 3.

FIG. 12 shows still another example of the operation for selecting a screen from virtual screens by using the screen selection program of FIG. 3.

FIG. 13 is an exemplary conceptual view illustrating an example in which a screen is selected by an operation of designating a direction by using the screen selection program of FIG. 3.

FIG. 14 is an exemplary conceptual view illustrating examples of a window generating operation and a screen selection operation, which are detected by the screen selection program of FIG. 3.

FIG. 15 is an exemplary flowchart illustrating an example of the procedure of a screen selection process executed by the screen selection program of FIG. 3.

### DETAILED DESCRIPTION

Various embodiments will be described hereinafter with reference to the accompanying drawings.

In general, according to one embodiment, an information processing apparatus includes a screen arrangement information storing module, a window generating operation detector, a selection operation detector, a screen determination module, and a window display module. The screen arrangement information storing module store screen arrangement information indicative of an arrangement of screens. The window generating operation detector detects a window generating operation for generating a window. The selection operation detector detects a selection operation for selecting a screen which is to display the window from the screens, in response to detection of the window generating operation. The screen determination module determines the screen which is to display the window, based on the selection operation and the screen arrangement information. The window display module displays the window on the determined screen.

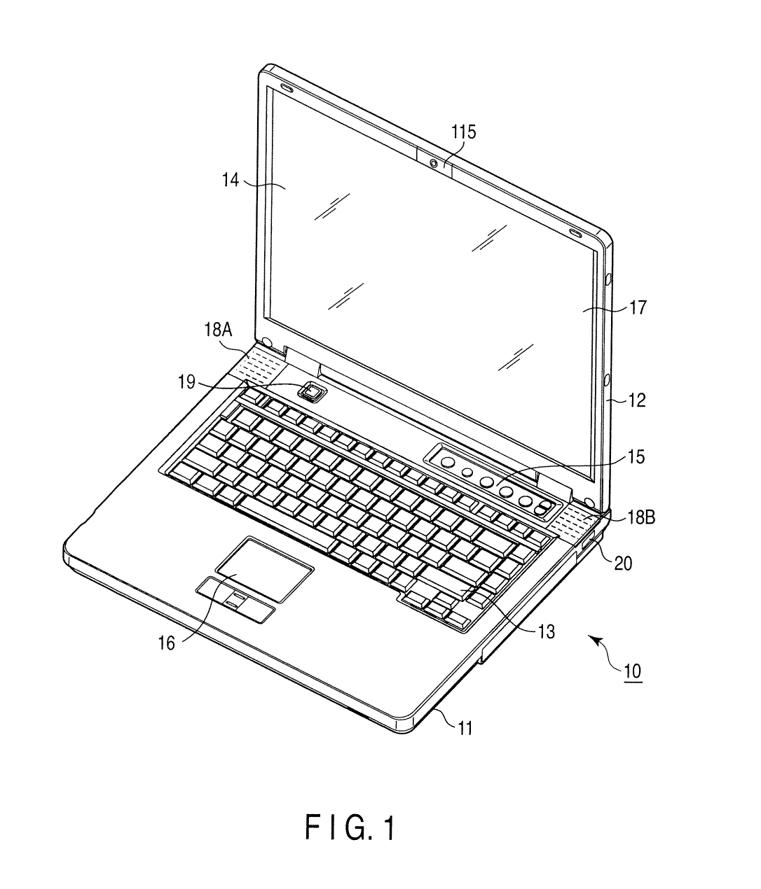

FIG. 1 is a view showing the external appearance of an information processing apparatus according to an embodiment. The information processing apparatus is realized, for example, as a notebook-type personal computer 10.

As shown in FIG. 1, the computer 10 includes a computer main body 11 and a display unit 12. A display device including a liquid crystal display (LCD) 17 is built in the display unit 12. In addition, a touch panel 14 is built in the display unit 12 in a manner to cover the surface of the LCD 17. The display unit 12 is attached to the computer main body 11 such that the display unit 12 is rotatable between an open position where the top surface of the computer main body 11 is exposed, and a closed position where the top surface of the computer main body 11 is covered. The display unit 12 further includes a camera module 115 above the LCD 17. The camera module 115 is used in order to capture, for instance, an image of the user of the computer 10, when the display unit 12 is in the open position where the top surface of the computer main body 11 is exposed.

The computer main body 11 has a thin box-shaped housing. A keyboard 13, an input operation panel 15, a touch pad 16, speakers 18A and 18B, and a power button 19 for powering on/off the computer 10 are disposed on the top surface of the housing of the computer main body 11. Various operation buttons are provided on the input operation panel 15.

The rear surface of the computer main body 11 is provided with an external display connection terminal (not shown) which supports, e.g. the high-definition multimedia interface (HDMI) standard. This external display connection terminal is used in order to output a digital video signal to an external display.

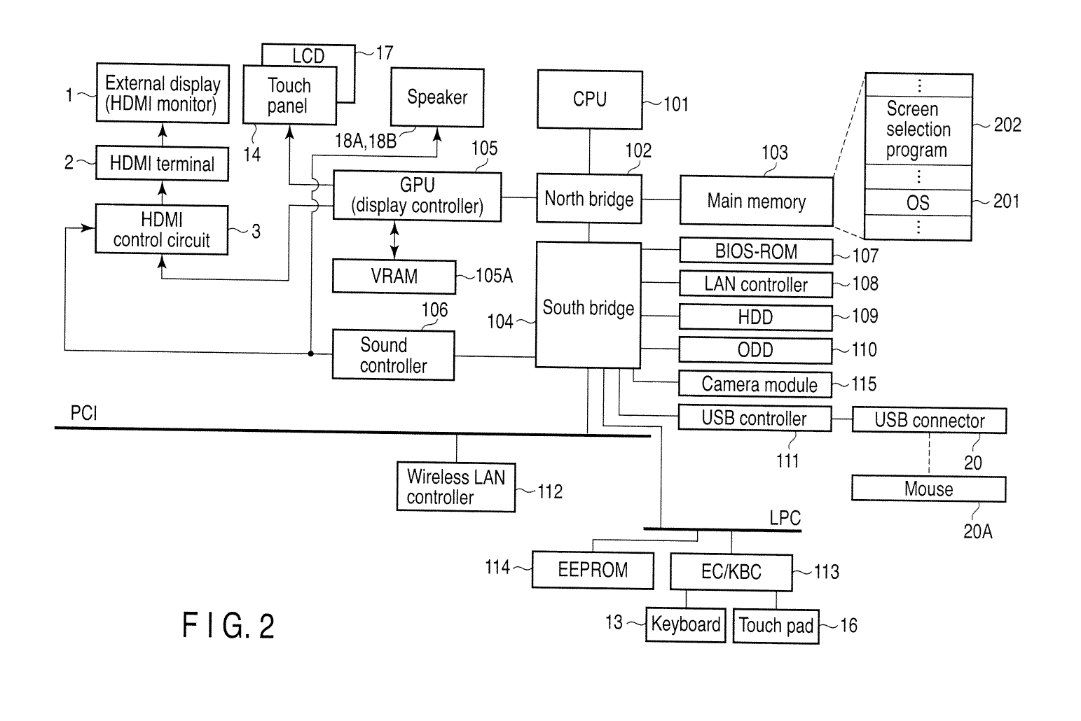

FIG. 2 shows the system configuration of the computer 10.

The computer 10, as shown in FIG. 2, includes a CPU 101, a north bridge 102, a main memory 103, a south bridge 104, a graphics processing unit (GPU) 105, a video RAM (VRAM) 105A, a sound controller 106, a BIOS-ROM 107, a LAN controller 108, a hard disk drive (HDD) 109, an optical disc drive (ODD) 110, a USB controller 111, a wireless LAN controller 112, an embedded controller/keyboard controller (EC/KBC) 113, an EEPROM 114, and a camera module 115.

The CPU 101 is a processor for controlling the operation of respective components in the computer 10. The CPU 101 executes an operating system (OS) 201 and various application programs, such as a screen selection program 202, which are loaded from the HDD 109 into the main memory 103. The screen selection program 202 is software having a function of displaying a window on a screen selected from screens of display devices (e.g. dual display or multi-display), or from virtual screens (e.g. virtual desktop). Responding to detection of an operation for generating a window, such as an operation for starting an application or an operation for opening a file, the screen selection program 202 further detects an operation of selecting one of screens. The screen selection program 202 also has a function of displaying objects indicative of candidates of screens which can display a window. Besides, the CPU 101 executes a BIOS stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of communicating with the GPU 105 via, e.g. a PCI EXPRESS serial bus.

The GPU 105 is a display controller which controls the LCD 17 used as a display monitor of the computer 10. A display signal, which is generated by the GPU 105, is sent to the LCD 17. In addition, the GPU 105 can send a digital video signal to an external display device 1 via an HDMI control circuit 3 and an HDMI terminal 2.

The HDMI terminal 2 is the above-described external display connection terminal. The HDMI terminal 2 is capable of sending a non-compressed digital video signal and a digital audio signal to the external display device 1, such as a TV, via a single cable. The HDMI control circuit 3 is an interface for sending a digital video signal to the external display device 1, which is called “HDMI monitor”, via the HDMI terminal 2.

The south bridge 104 controls devices on a peripheral component interconnect (PCI) bus and devices on a low pin count (LPC) bus. The south bridge 104 includes an integrated drive electronics (IDE) controller for controlling the HDD 109 and ODD 110. The south bridge 104 also has a function of communicating with the sound controller 106.

The sound controller 106 is a sound source device and outputs audio data, which is a target of playback, to the speakers 18A and 18B or the HDMI control circuit 3.

The LAN controller 108 is a wired communication device which executes wired communication of, e.g. the IEEE 802.3 standard. On the other hand, the wireless LAN controller 112 is a wireless communication device which executes wireless communication of, e.g. the IEEE 802.11g standard. The USB controller 111 executes communication with an external device which supports, e.g. the USB 2.0 standard (the external device is connected via the USB connector 19). For example, the USB controller 111 detects an operation by a mouse 20A connected via the USE connector 20. The USB controller 111 sends a control signal corresponding to the detected operation to the CPU 101 via the south bridge 104.

The camera module 115 executes an imaging process using a built-in camera. The camera module 115 generates image data by using, e.g. an image captured by the built-in camera, and executes, e.g. communication for storing the image data in the main memory 103 or HDD 109. In addition, the camera module 115 supplies the image data to various application programs such as the screen selection program 202.

The EC/KBC 113 is a one-chip microcomputer in which an embedded controller for power management and a keyboard controller for controlling the keyboard 13 and touch pad 16 are integrated. The EC/KBC 113 has a function of powering on/off the computer 10 in accordance with the user's operation of the power button 19.

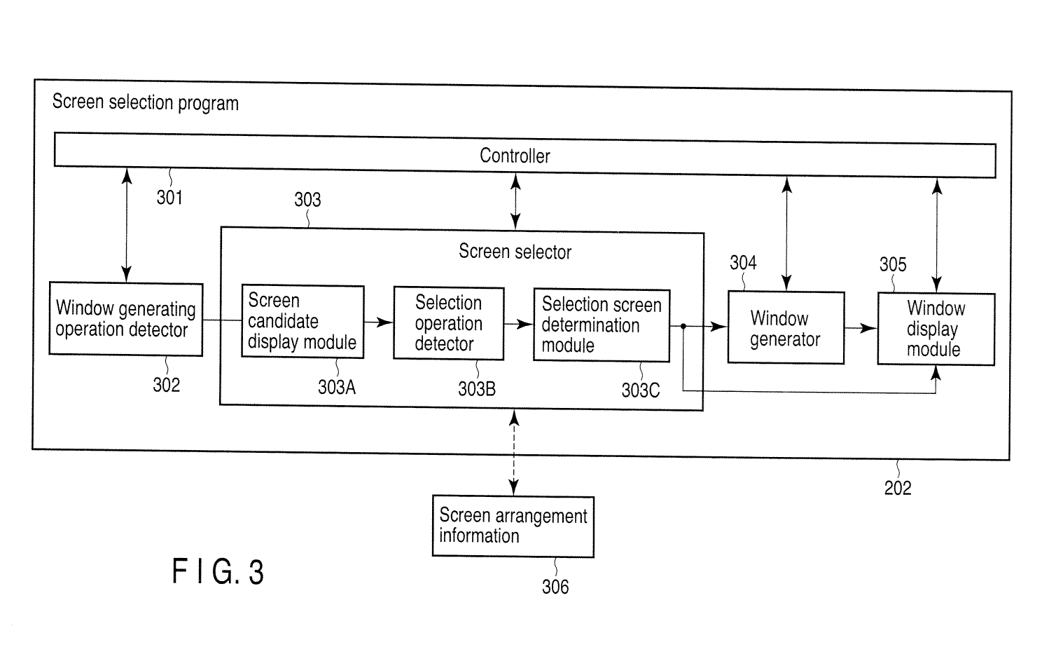

Next, referring to FIG. 3, a description is given of a functional structure of the screen selection program 202 which runs on the computer 10. The screen selection program 202 displays a window on a screen selected from screens of display devices or from virtual screens. In the environment in which screens are set for the computer 10 (e.g. multi-display environment or virtual desktop environment), it is assumed, for example, that the user starts a work using a window of an application program, after the user starts the application program and then moves the window displayed on a screen to another screen. It is possible that such an operation of moving the window to another screen is time-consuming for the user. The screen selection program 202 of the embodiment detects an operation of designating the screen on which the window is to be displayed, before the window is displayed, without causing the user to perform, e.g. an operation of moving the displayed window to another screen. The screen selection program 202 then displays the window on the screen designated by the detected operation. Thus, using the screen selection program 202, the user can display the window on an arbitrary screen at the same time as the start of the application program, by performing a series of operations including, for example, an operation (action) of starting the application program and an operation of designating the screen on which the window is to be displayed. The operation of designating the screen indicates, for example, the directions in which screens of display devices or virtual screens are physically or logically present.

The screen selection program 202 includes a controller 301, a window generating operation detector 302, a screen selection module 303, a window generator 304, and a window display module 305. The controller 301 controls the operations of the respective modules in the screen selection program 202.

The window generating operation detector 302 detects an operation for generating a window (a window generating operation). The window generating operation detector 302 detects, for example, an operation of starting an application program, or an operation of opening a file or directory which is associated with the application program. To be more specific, the window generating operation detector 302 detects, for example, an operation of clicking an icon on the active screen (the screen in operation) by using the mouse 20A, touch pad 16 or touch panel 14. The window generating operation is not limited to the above-described examples, and may be any operation, in response to which a window is generated and displayed on the screen. The window generating operation detector 302 notifies the screen selection module 303 of the detection of the window generating operation.

The screen selection module 303 includes a screen candidate display module 303A, a selection operation detector 303B, and a selection screen determination module 303C. The screen selection module 303 reads screen arrangement information 306 in the HDD 109, etc. The screen arrangement information 306 includes information of the number of screens, such as screens of display devices or virtual screens, which are set on the computer 10, the positions of the screens, and the sizes of the screens. The screen arrangement information 306 can be managed by the OS or various programs. In addition, the screen arrangement information 306 may be input by the user.

The screen candidate display module 303A detects, using the screen arrangement information 306, the screens on which a window generated in association with the window generating operation can be displayed. The screen candidate display module 303A then displays objects representing the detected screens on the active screen.

The selection operation detector 303B detects an operation (screen selection operation) of selecting one of the screens which can display the window. The selection operation detector 303B detects a screen selection operation by which the user selects an object corresponding to a screen on which the window is to be displayed, from the objects displayed by the screen candidate display module 303A. The selection operation detector 303B notifies the selection screen determination module 303C of the detected screen selection operation.

The selection screen determination module 303C determines the screen on which the window is to be displayed, based on the screen selection operation reported from the selection operation detector 303B and the screen arrangement information 306. The selection screen determination module 303C determines, for example, the screen corresponding to the object, which is selected by the screen selection operation, to be the screen on which the window is to be displayed. The selection screen determination module 303C informs the window generator 304 of the screen which is to display the window has been determined. In addition, the selection screen determination module 303C sends to the window display module 305 the information indicative of the screen on which the window is to be displayed.

In the meantime, the selection operation detector 303B may detect a screen selection operation which designates, by a direction, a screen on which the window is to be displayed, from screens. In this case, the selection screen determination module 303C determines a screen, which is designated by the direction of the screen selection operation from the screens that can display the window, to be the screen which displays the window.

The window generator 304 generates the window corresponding to the window generating operation. For example, responding to the operation of starting an application program, the window generator 304 generates the window corresponding to this application program. In addition, responding to the operation of opening a file associated with the application program, the window generator 304 generates the window corresponding to the application program associated with this file.

The window display module 305 displays the window, which has been generated by the window generator 305, on the screen which has been determined by the selection screen determination module 303C. Thereby, the screen selection program 202 can display the window, which is generated in accordance with the window generating operation, on the screen designated by the screen selection operation from the screens of display devices or from virtual screens. Triggered by the detection of the window generating operation, the screen selection program 202 transitions to the mode of detecting the screen selection operation. At this time, the screen selection program 202 may display, as described above, the objects representing the screens which can display the window, and may prompt the user to perform the screen selection operation.

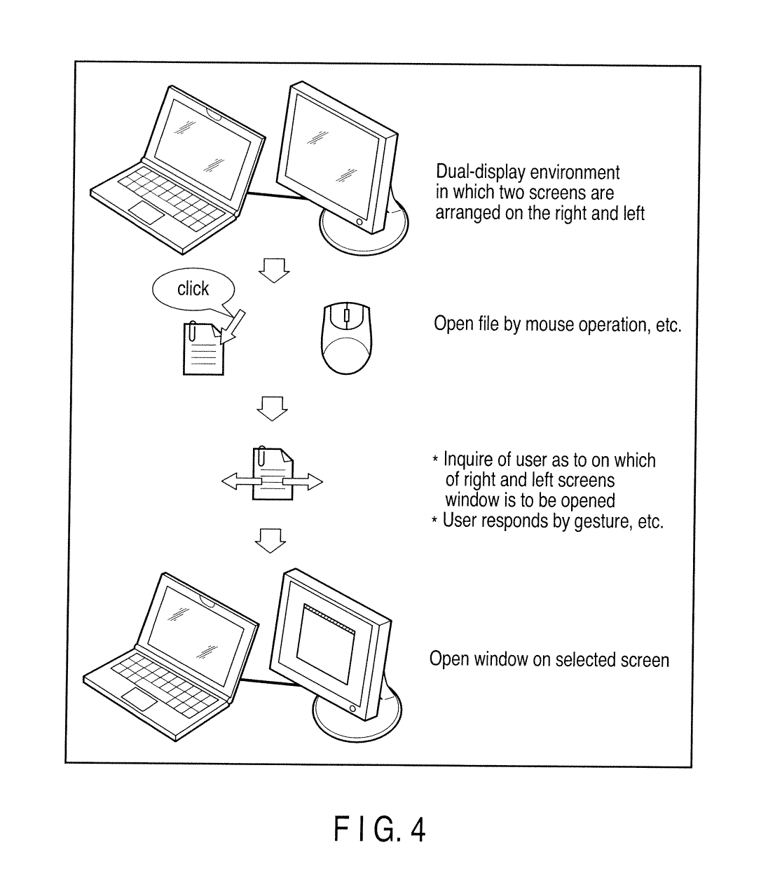

FIG. 4 illustrates an example of the operation of the screen selection performed by using the screen selection program 202. In this example, a description is given of a dual-display environment in which the screens of two display devices are arranged on the right and left.

To start with, the user performs, for example, an operation of opening a file corresponding to an icon displayed on the screen, by clicking this icon by the mouse. Responding to the operation of opening the file, the screen selection program 202 inquires of the user as to which of the left screen and right screen is to display the window. The screen selection program 202 displays objects representing the screens, which can display the window, around the clicked icon. The displayed objects are, for example, an object of a leftward arrow and an object of a rightward arrow, which correspond to the left screen and right screen that are capable of displaying the window, as shown in FIG. 4. The user responds to this inquiry by an operation of selecting the screen (e.g. gesture, key input). Specifically, the user selects the screen, for example, by clicking, with use of the mouse 20A, the object corresponding to the screen on which the window is to be displayed, from the above-described objects. Alternatively, the user selects the screen, for example, by pressing a direction key (e.g. the input of the “←” key or “→” key) on the keyboard 13, which corresponds to the screen on which the window is to be displayed. The screen selection program 202 displays the window on the screen which has been selected by the screen selection operation by the user.

As has been described above, the screen selection program 202 detects the window generating operation such as the operation of opening a file, and then detects the screen selection operation of selecting the screen which is to display the window. Based on the two detected operations, the screen selection program 202 displays the window corresponding to the window generating operation on the screen which has been selected by the screen selection operation.

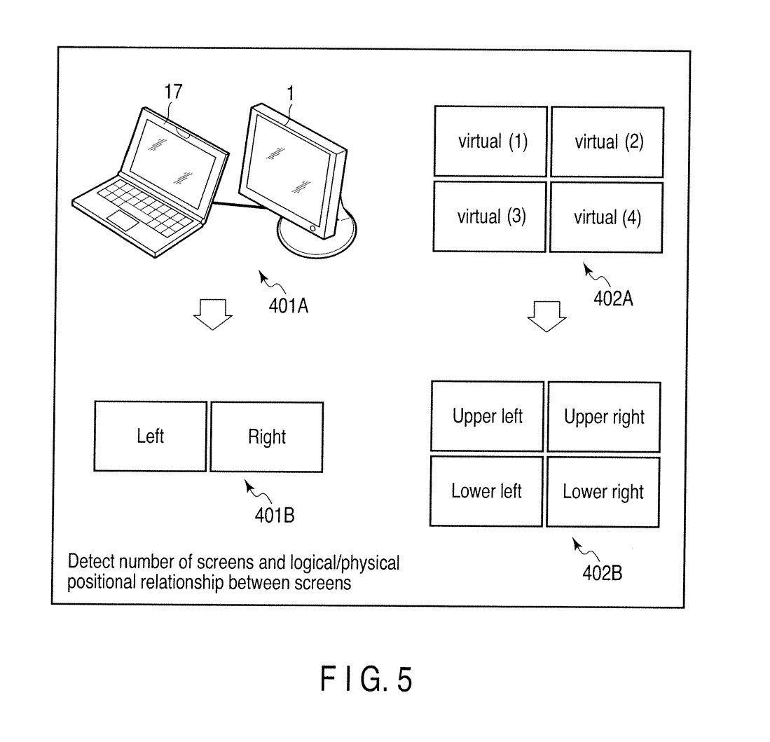

In the meantime, the screens set for the computer 10 are not limited to the screens of display devices, and may be virtual screens. Using the screen arrangement information 306 indicative of the arrangement of screens set for the computer 10, the screen selection program 202 determines one screen which is to display the window. FIG. 5 shows an example of the screen arrangement information 306 used by the screen selection program 202.

Screens 401A of display devices include, for example, the screen of the LCD 17 and the screen of the external display device 1. In this case, screen arrangement information 401B includes information indicating that the screen of the LCD 17 is disposed on the left side and the screen of the external display device 1 is disposed on the right side. Accordingly, the screen arrangement information 401B includes information indicating that two screens comprising the screen of the LCD 17 and the screen of the external display device 1 are set on the computer 10, and information indicative of the physical positions and sizes of the respective screens.

Virtual screens 402A include, for example, four virtual screens. In this case, screen arrangement information 402B includes information indicating that a first virtual screen is disposed on an upper left side, a second virtual screen is disposed on an upper right side, a third virtual screen is disposed on a lower left side, and a fourth virtual screen is disposed on a lower right side. Accordingly, the screen arrangement information 402B includes information indicating, for example, that four virtual screens are set on the computer 10, and information indicative of the logical positions and sizes of the respective screens. Specifically, the screen arrangement information 306 indicates the number of screens set on the computer 10 and the logical or physical positional relationship between the screens. The screen arrangement information 306 can be managed by the OS or various programs.

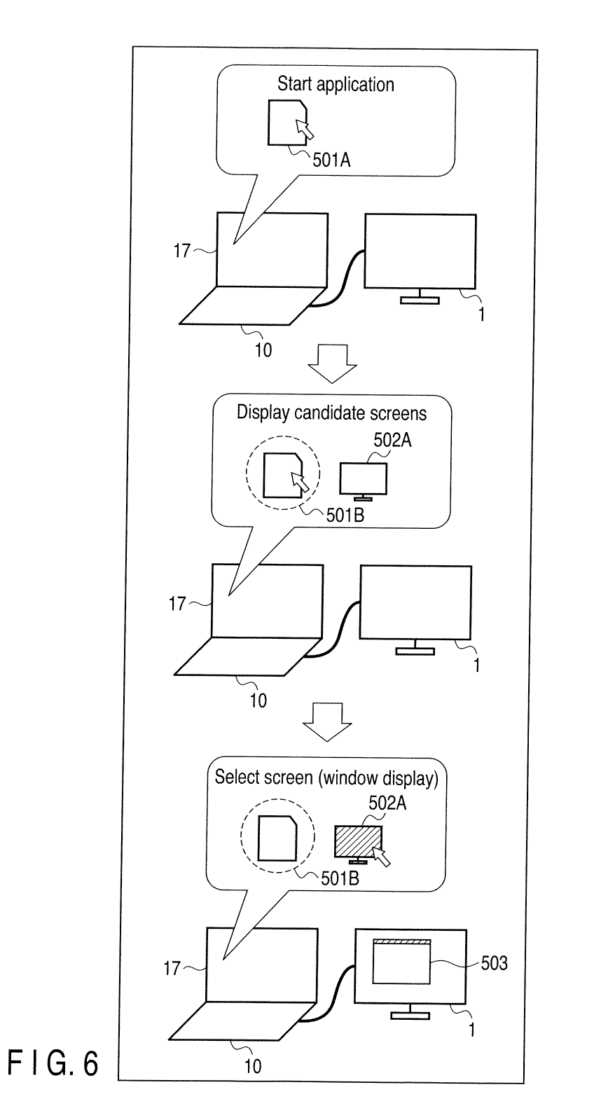

Next, referring to FIG. 6, a description is given of an example of the operation of selecting one screen from the screens of display devices by using the screen selection program 202. It is assumed that the screen of the LCD 17 and the screen of the external display device 1 are set on the computer 10.

To start with, the screen selection program 202 detects, for example, an operation of starting an application program. Specifically, the screen selection program 202 detects that an application program is started by an operation of clicking an icon 501A displayed on the screen of the LCD 17.

Subsequently, the screen selection program 202 displays on the active screen (the screen of the LCD 17 in this case) objects 501B and 502A representing the screens which can display a window 503 corresponding to the started application program. The object 501B is such an object that the icon 501A is displayed with emphasis (circular dotted line) indicating a screen selection mode. The object 501B is also a candidate object for designating the window 503 to be displayed on the active screen of the LCD 17. The object 502A is a candidate object for designating the window 503 to be displayed on the screen of the external display device 1. The user selects, from the candidate objects 501B and 502A, the candidate object corresponding to the screen on which the window 503 is to be displayed. The user selects the candidate object, for example, by clicking the candidate object by the mouse.

The screen selection program 202 determines the screen which is to display the window 503, responding to, e.g. the user's operation of clicking the candidate object. It is assumed that the candidate object 502A has been selected. In this case, the screen selection program 202 displays the window 503 on the screen of the external display device 1 corresponding to the candidate object 502A.

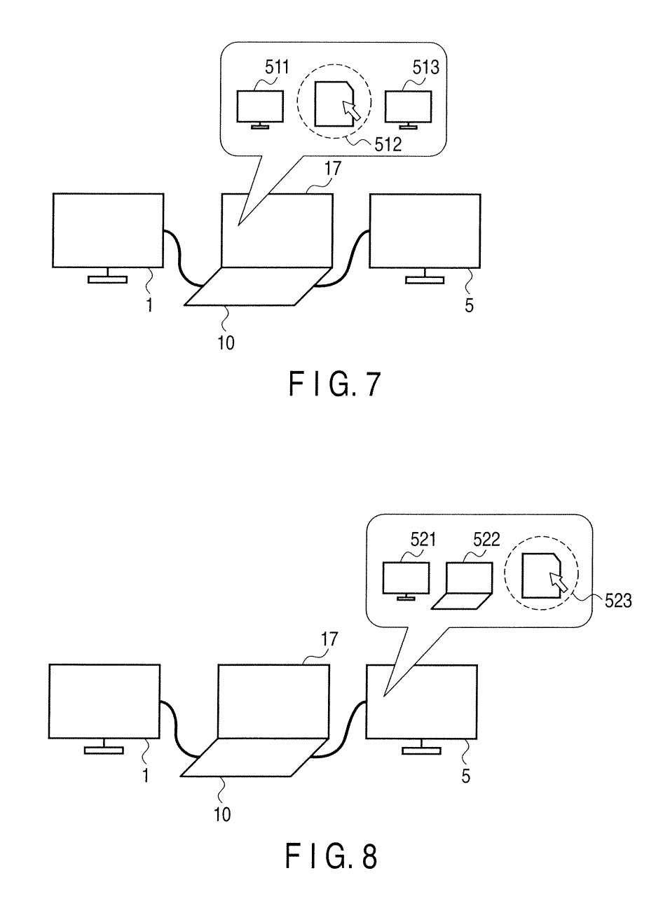

As has been described above, the screen selection program 202 displays on the active screen objects representing screens which can display a window, and displays the window on the screen corresponding to the object selected from the objects. FIG. 7 to FIG. 9 show other examples of the operation of selecting a screen which is to display a window, from the screens of display devices. In the examples of FIG. 7 to FIG. 9, it is assumed that three screens, which include the screen of the LCD 17, the screen of the external display device 1 and the screen of an external display monitor 5, are set on the computer 10.

In FIG. 7, the screen selection program 202 displays, on the active screen of the LCD 17, candidate objects 511, 512 and 513 representing screens which can display a window, responding to an operation of clicking an icon displayed on the screen of the LCD 17. Specifically, the candidate object 511 representing the screen of the external display device 1 is displayed on the left side, the candidate object 512 representing the screen of the LCD 17 is displayed at the center, and the candidate object 513 representing the screen of the external display monitor 5 is displayed on the right side. The user selects, from these candidate objects 511, 512 and 513, the object corresponding to the screen on which the window is to be displayed.

In FIG. 8, the screen selection program 202 displays, on the active screen of the external display monitor 5, candidate objects 521, 522 and 523 representing screens which can display a window, responding to an operation of clicking an icon displayed on the screen of the external display monitor 5. Specifically, the candidate object 521 representing the screen of the external display device 1 is displayed on the left side, the candidate object 522 representing the screen of the LCD 17 is displayed at the center, and the candidate object 523 representing the screen of the external display monitor 5 is displayed on the right side. The user selects, from these candidate objects 521, 522 and 523, the object corresponding to the screen on which the window is to be displayed.

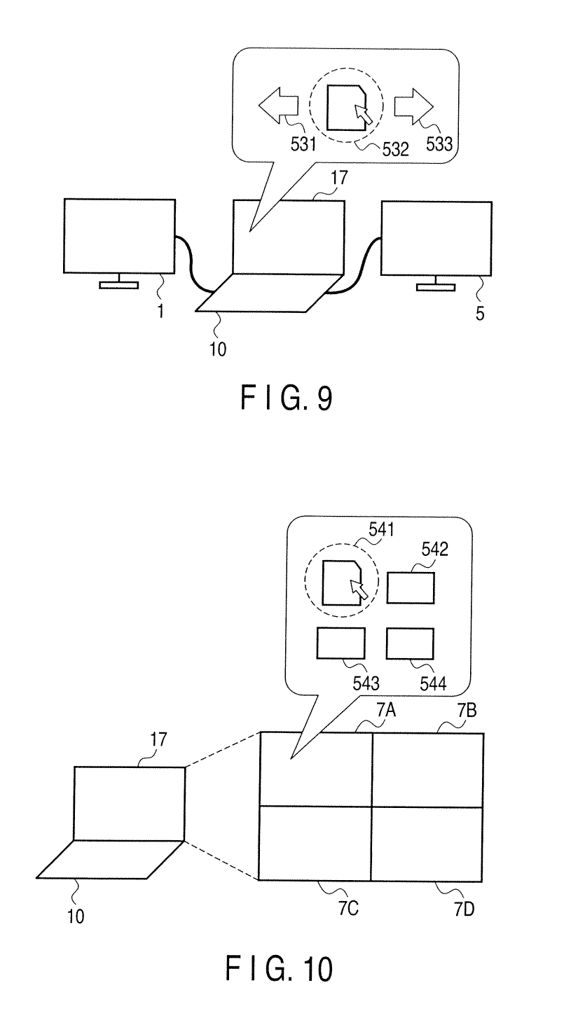

In FIG. 9, the screen selection program 202 displays, on the active screen of the LCD 17, candidate objects 531, 532 and 533 representing screens which can display a window, responding to an operation of clicking an icon displayed on the screen of the LCD 17. Specifically, the candidate object 531 of a leftward arrow, which indicates the screen (the screen of the external display device 1) on the left side of the active screen of the LCD 17, is displayed on the left side. The candidate object 532 representing the screen of the LCD 17 is displayed at the center. The candidate object 533 of a rightward arrow, which indicates the screen (the screen of the external display monitor 5) on the right side of the active screen of the LCD 17, is displayed on the right side. The user selects, from these candidate objects 531, 532 and 533, the object corresponding to the screen on which the window is to be displayed. In the meantime, the operation of selecting either the left screen or right screen (the screen of the external display device 1 or the screen of the external display monitor 5) is not limited to the operation of clicking the candidate object 531 or 533, and may be, for example, a gesture operation indicating a direction, using the mouse 20A, touch panel 14 or touch pad 16. For example, the operation of clicking the candidate object 531 representing the leftward arrow may be replaced with an operation of sliding the finger from the right to the left on the touch panel 14. In addition, the operation of clicking the candidate object 533 representing the rightward arrow may be replaced with an operation of sliding the finger from the left to the right on the touch pad 16. When the screen is selected by the gesture operation, the screen selection program 202 may not display the candidate objects on the screen.

FIG. 10 to FIG. 12 show examples of the operation of selecting a screen which is to display a window, from virtual screens. In the examples of FIG. 10 to FIG. 12, it is assumed that four virtual screens 7A, 7B, 7C and 7D are set on the computer 10.

In FIG. 10, the screen selection program 202 displays, on the active virtual screen 7A (the virtual screen 7A in operation), candidate objects 541, 542, 543 and 544 representing screens which can display a window, responding to an operation of clicking an icon displayed on the virtual screen 7A. Specifically, the candidate object 541 representing the virtual screen 7A is displayed on the upper left side, the candidate object 542 representing the virtual screen 7B is displayed on the upper right side, the candidate object 543 representing the virtual screen 7C is displayed on the lower left side, and the candidate object 544 representing the virtual screen 7D is displayed on the lower right side. The user selects, from these candidate objects 541, 542, 543 and 544, the object corresponding to the screen on which the window is to be displayed.

In FIG. 11, the screen selection program 202 displays, on the active virtual screen 7A, candidate objects 551, 552, 553 and 554 representing screens which can display a window, responding to an operation of clicking an icon displayed on the virtual screen 7A. Specifically, the candidate object 551 indicating the active virtual screen 7A is displayed at the center, the candidate object 552 of a rightward arrow, which indicates the virtual screen 7B is displayed on the right side, the candidate object 554 of a downward arrow, which indicates the virtual screen 7C, is displayed on the lower side, and the candidate object 553 of a lower-rightward arrow, which indicates the virtual screen 7D, is displayed on the lower right side. The user selects, from these candidate objects 551, 552, 553 and 554, the object corresponding to the screen on which the window is to be displayed. In the meantime, the operation of selecting one of the virtual screens 7B, 7C and 7D is not limited to the operation of clicking the candidate object 552, 553 or 554, and may be, for example, a gesture operation indicating a direction, using the mouse 20A, touch panel 14 or touch pad 16. For example, the operation of clicking the candidate object 552 representing the rightward arrow may be replaced with an operation of sliding the finger from the left to the right on the touch panel 14. In addition, the operation of clicking the candidate object 553 representing the lower-rightward arrow may be replaced with an operation of sliding the finger from the upper left to the lower right on the touch pad 16.

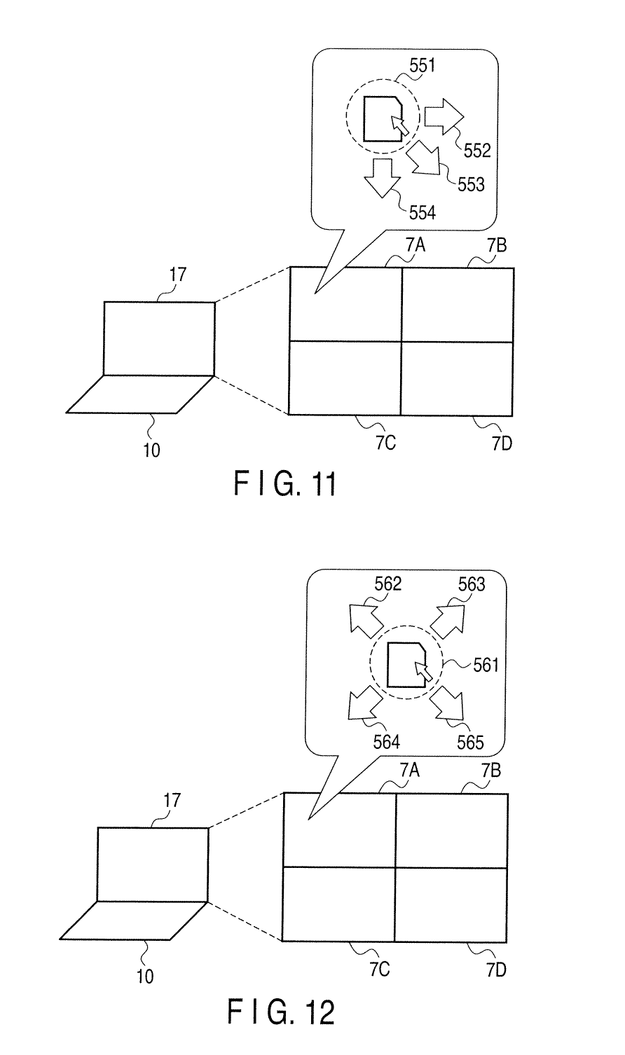

In FIG. 12, the screen selection program 202 displays, on the active virtual screen 7A, candidate objects 562, 563, 564 and 565 representing screens which can display a window, responding to an operation of clicking an icon 561 displayed on the virtual screen 7A. Specifically, relative to the icon 561 displayed at the center, the candidate object 562 of an upper-leftward arrow, which indicates the active virtual screen 7A, is displayed on the upper left side, the candidate object 563 of an upper-rightward arrow, which indicates the virtual screen 7B, is displayed on the upper right side, the candidate object 564 of a lower-leftward arrow, which indicates the virtual screen 7C, is displayed on the lower left side, and the candidate object 565 of a lower-rightward arrow, which indicates the virtual screen 79, is displayed on the lower right side. The user selects, from these candidate objects 562, 563, 564 and 565, the object corresponding to the screen on which the window is to be displayed. In the meantime, as has been described with reference to FIG. 11, etc., the operation of selecting one of the virtual screens 7A to 7D may be a gesture operation indicating a direction, using the mouse 20A, touch panel 14 or touch pad 16. When the gesture operation indicating a direction, for example, is input, the screen selection program 202 determines the screen which is to display the window, based on the designated direction and the screen arrangement information 306.

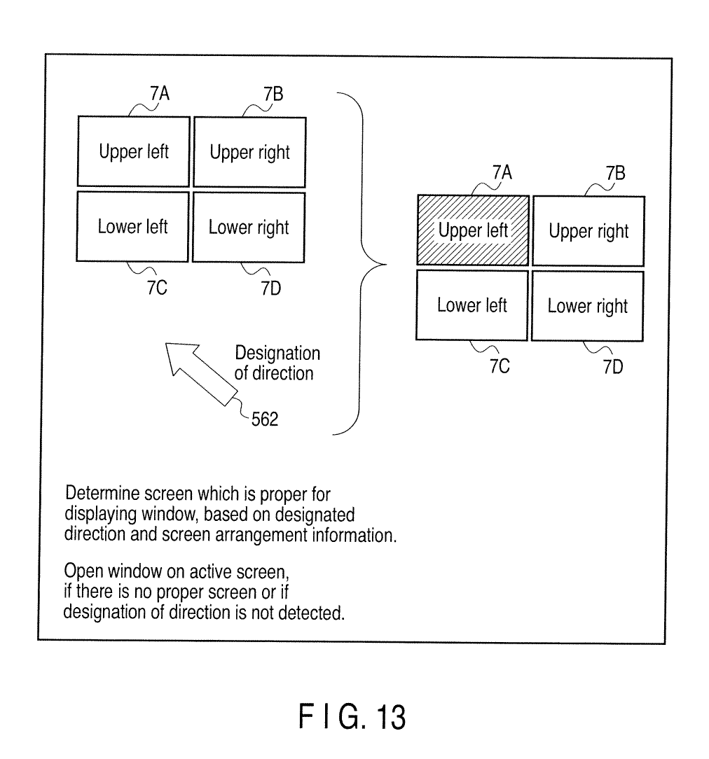

FIG. 13 shows an example in which a screen which is to display a window is determined based on the designated direction 562 and screen arrangement information 306. It is assumed that four virtual screens 7A to 79 are set on the computer 10. Accordingly, the screen arrangement information 306 includes information indicative of the arrangement of the four virtual screens 7A to 7D. When the input of the direction 562 is detected, the screen selection program 202 estimates the virtual screen 7A, which is most proper, based on the direction 562 and screen arrangement information 306. The screen selection program then determines the virtual screen 7A to be the screen on which the window is to be displayed. In the meantime, when there is no proper screen or the input of the direction cannot be detected, the window is displayed on a predetermined screen (e.g. the active screen).

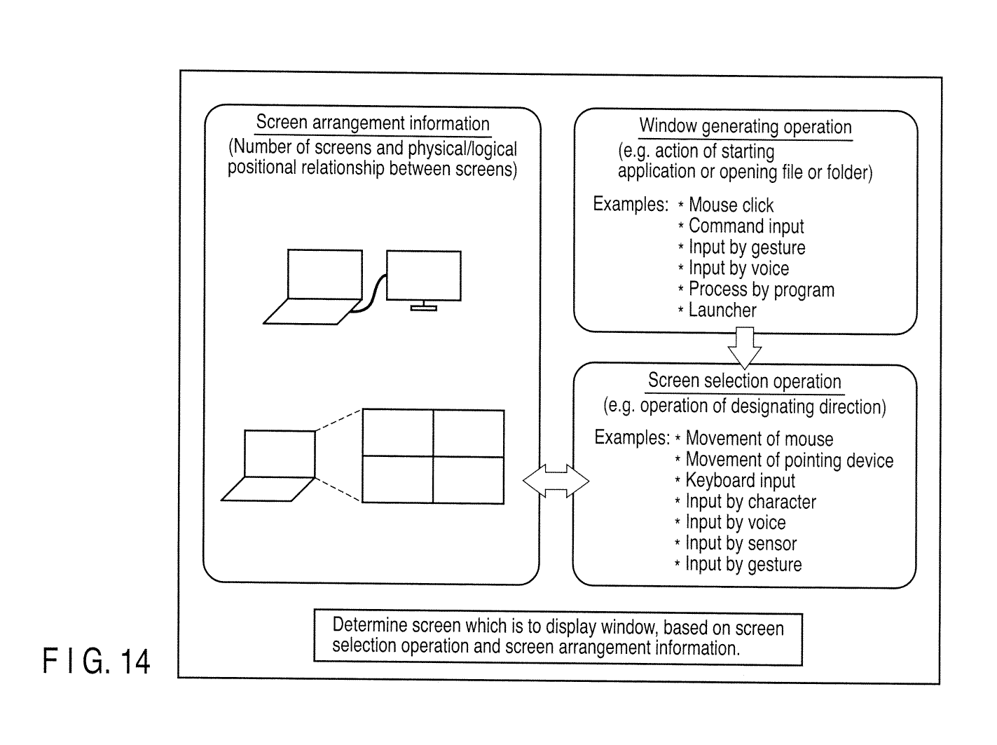

FIG. 14 illustrates examples of the window generating operation and screen selection operation, which are detected by the screen selection program 202. The screen selection program 202, as described above, detects the window generating operation, such as the operation of starting an application program or the operation of opening a file or a folder. A click using the mouse 20A, a command input using the keyboard 13, etc., an input by a gesture using the camera module 115, etc., an input by voice using a microphone (not shown), or a process by a program (e.g. launcher) may be used as the window generating operation.

In addition, the screen selection program 202 detects the screen selection operation, such as the operation of selecting the object representing the screen which can display a window, or the operation of designating the direction. A movement of a pointing device such as the mouse 20A, touch panel 14 or touch pad 16, an input by the keyboard 13, an input by characters, an input by voice using a microphone, an input by various sensors, or an input by a gesture using the camera module 115, etc. are used as the screen selection operation.

Triggered by the detection of the window generating operation, the screen selection program 202 detects the screen selection operation (i.e. the screen selection program 202 transitions to the mode of detecting the screen selection operation). Based on the screen selection operation and the screen arrangement information 306 indicative of the number of screens and the physical/logical positional relationship between the screens, the screen selection program 202 determines the screen which is to display the window. Then, the screen selection program 202 displays the window corresponding to the window generating operation on the screen determined based on the screen selection operation.

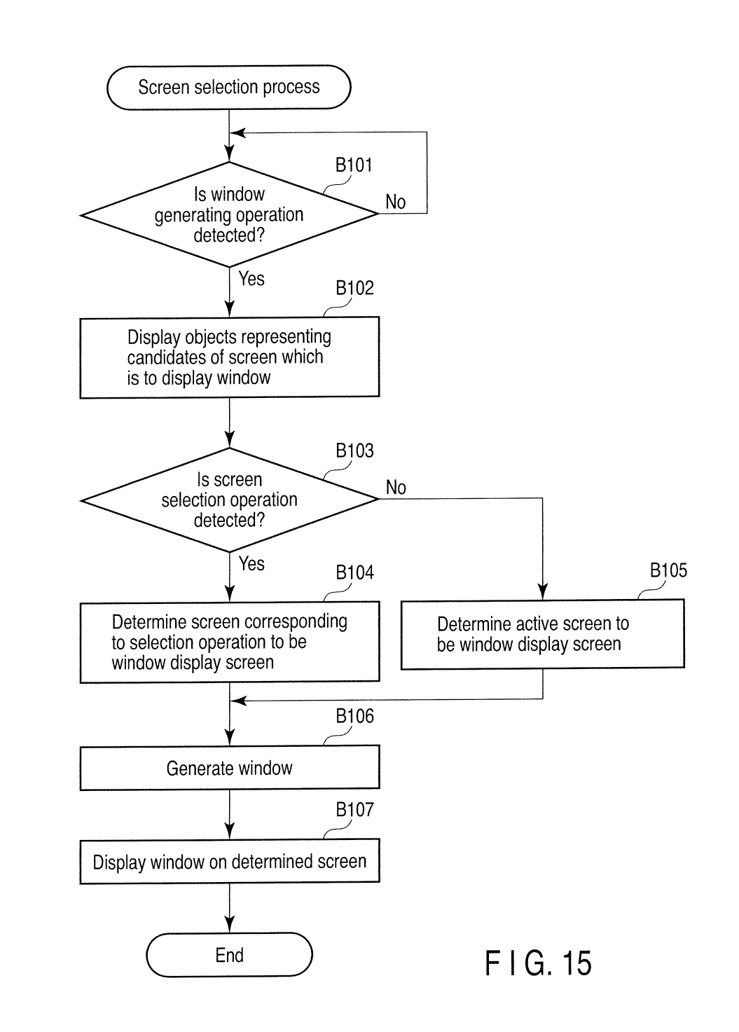

Next, referring to a flowchart of FIG. 15, a description is given of an example of the procedure of the screen selection process executed by the screen selection program 202.

To start with, the screen selection program 202 detects an operation for generating a window (window generating operation) (block B101). If the window generating operation is detected (YES in block B101), the screen selection program 202 displays objects representing screens which can display the window, on the active screen (the screen in operation) (block B102).

Then, the screen selection program 202 detects an operation (screen selection operation) of selecting one object from the objects representing the screens (block B103). Referring to the screen arrangement information 306, the screen selection program 202 determines the screen, which corresponds to the screen selection operation, to be the screen (window display screen) which is to display the window (block B104). If the screen selection operation is not detected (NO in block B103), the screen selection program 202 determines the active screen to be the window display screen (block B105).

Subsequently, the screen selection program 202 generates a window corresponding to the window generating operation detected in block B101 (block B106). The screen selection program 202 displays the generated window on the window display screen determined in block B104 or block B105 (block B107).

By the above-described process, the screen selection program 202 can display the window, which is generated in accordance with the window generating operation, on the screen designated by the screen selection operation from the screens of the display devices or from the virtual screens. Thus, since in order to display on another screen the window that is currently displayed on the screen, the user is not required to perform, e.g. an operation of shifting the window to this other screen, it is possible to reduce the load of the operation which is to display the window on an arbitrary one of the screens. The user selects the screen, on which the window is to be displayed, by the operation of selecting an object, which corresponds to the screen on which the window is to be displayed, from the objects representing the screens which can display the window, or by the operation of designating the direction in which the screen, on which the window is to be displayed, is physically or logically present. Since this screen selection operation can be performed by using the mouse 20A, touch panel 14, etc., the user can select the screen which is to display the window, by an intuitive, simple operation.

As has been described above, according to the present embodiment, the load of the operation which is to display the window on an arbitrary one of screens can be reduced. Responding to the detection of the window generating operation, such as an operation for starting an application program, the screen selection program 202 detects the screen selection operation of selecting the screen for displaying the window generated by the window generating operation. Then, the screen selection program 202 displays the window, which is generated in response to the window generating operation, on the screen designated by the screen selection operation from the screens of the display devices or from the virtual screens. Thereby, for example, when an application program is started, the user can display the window on an arbitrary screen at the same time as the start of the application program, without doing such a time-consuming work as shifting the window to another arbitrary screen after the window is displayed on the screen.

All the procedures of the screen selection process of this embodiment may be executed by software. Thus, the same advantageous effects as with the present embodiment can easily be obtained simply by installing a computer program, which executes the procedures of the screen selection process, into an ordinary computer through a computer-readable storage medium.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a screen arrangement information storing module configured to store screen arrangement information indicative of an arrangement of screens;
a window generating operation detector configured to detect a window generating operation for generating a window;
a selection operation detector configured to detect a selection operation for selecting a screen which is to display the window from the screens, in response to detection of the window generating operation;
a screen determination module configured to determine the screen which is to display the window, based on the selection operation and the screen arrangement information; and
a window display module configured to display the window on the determined screen.

2. The information processing apparatus of claim 1, further comprising a candidate display module configured to display, based on the screen arrangement information, objects representing screens, respectively, which are capable of displaying the window, in response to the detection of the window generating operation,
wherein the selection operation detector is configured to detect an object selected from the objects, and
the screen determination module is configured to determine the screen corresponding to the selected object to be the screen which is to display the window.

3. The information processing apparatus of claim 1, wherein the screens comprises screens of display devices, and
the screen arrangement information comprises information indicative of an arrangement of the screens of the display devices.

4. The information processing apparatus of claim 1, wherein the screens comprises virtual screens, and
the screen arrangement information comprises information indicative of a logical arrangement of the virtual screens.

5. The information processing apparatus of claim 1, wherein the window comprises a window corresponding to an application program, and
the window generating operation detector is configured to detect an operation of starting the application program.

6. The information processing apparatus of claim 1, wherein the window comprises a window corresponding to an application program associated with a file, and
the window generating operation detector is configured to detect an operation of opening the file.

7. The information processing apparatus of claim 2, wherein the objects comprises objects which represents directions toward the screens which are capable of displaying the window.

8. A screen selection method comprising:
detecting a window generating operation for generating a window;
detecting a selection operation for selecting a screen for displaying the window, from screens, in response to detection of the window generating operation;
determining the screen which is to display the window, based on the selection operation and screen arrangement information indicative of an arrangement of the screens; and
displaying the window on the determined screen.

9. A program to cause a computer to perform a screen selection processing, the program comprising:
causing the computer to detect a window generating operation for generating a window;
causing the computer to detect a selection operation for selecting a screen which is to display the window, from screens, in response to detection of the window generating operation;
causing the computer to determine the screen which is to display the window, based on the selection operation and screen arrangement information indicative of an arrangement of the screens; and
causing the computer to display the window on the determined screen.
